(19) United States
(12) Patent Application Publication
(10) Pub. No.: US 2022/0292315 A1
(43) Pub. Date: Sep. 15, 2022

(54) ACCELERATED K-FOLD CROSS-VALIDATION

(71) Applicant: Minitab, LLC, State College, PA (US)

(72) Inventors: Senin J. Banga, State College, PA (US); Robert E. Kelly, State College, PA (US)

(73) Assignee: Minitab, LLC, State College, PA (US)

(21) Appl. No.: 17/199,389

(22) Filed: Mar. 11, 2021

(51) Int. Cl. G06K 9/62; G06N 20/00

(52) U.S. Cl. CPC G06K 9/6265; G06K 9/6257; G06N 20/00

(57) ABSTRACT

Models are k-fold cross-validated to determine how results of an analysis will generalize to an independent data set. By obtaining an inverse transformation of a set of residuals representative of a traditional repetitive train-then-test approach, models can be k-fold cross-validated in an accelerated manner to reduce computational cost and eliminate or substantially eliminate restrictions on the number of folds to include in the cross-validation.

### TECHNICAL FIELD

The present invention relates generally to a method, system, and computer program product for accelerated cross-validation. More particularly, the present invention relates to a method, system, and computer program product for bypassing repetitive model fitting in k-fold cross-validation of linear models and generalized linear models to reduce computational costs.

### BACKGROUND

A practice in statistical model building and machine learning involves validating models using a criterion that reflects prediction capabilities. Learning the parameters of a prediction function using a set of data and testing it on the same data usually results in a model that correctly predicts data it has seen but fails at predicting useful information for yet-unseen data. This causes problems such as overfitting or selection bias. To avoid it, a part of an available training data set is held out and used as a test data set.

Cross-validation is an example of a model evaluation method that is used to assess the generalization ability of a predictive model and to prevent overfitting. It uses a subset of a data set to train a model while holding back a remaining portion of the data for testing to ensure robustness of the model. The remaining portion of the data is removed before training begins and the removed data is subsequently used to test the performance of the learned model. In an example, cross-validation is used to tune model parameters, for example, the optimal number of nearest neighbors in a k-nearest neighbor classifier. Here, cross-validation is applied multiple times for different values of the tuning parameter, and the parameter that minimizes the cross-validated error is then used to build a final model.

### SUMMARY

The illustrative embodiments provide a method, system, and computer program product for cross-validation. An embodiment is a method that acquires, via a predictive analytics engine of a learning machine, input data to be analyzed, the input data comprising a plurality of labeled cases. The embodiment trains a model, based on a parameter estimation procedure, by using the plurality of labelled cases. The embodiment randomly divides the plurality of labelled cases into a number of folds (k folds), and for each fold of the k folds, the embodiment computes a set of corresponding predicted residuals in the fold using an inverse transformation of residuals, referred to herein as ordinary residuals, that are representative of a difference between output values of the labelled cases in the fold and their estimated or fitted values, the corresponding predicted residuals being representative of a bypassed traditional repetitive model training-then-testing process. The embodiment receives k sets of corresponding predicted residuals; and determines a k-fold R-square statistic using all the members of the k sets of corresponding predicted residuals, the k-fold R-square statistic being indicative of a k-fold cross-validation error of the model.

In an aspect herein, the embodiment includes any combinations of the following: a computational cost of the learning machine is decreased by increasing the number of folds from a first number to a second higher number such that the computational cost approaches zero; the parameter estimation procedure is an ordinary least squares (OLS) method and the model is a linear model; the k-fold cross-validation error is used to parameter tune when building a regression tree; the parameter estimation procedure is an iterative reweighted least squares (IRLS) method and the model is a generalized linear model; the k-fold cross-validation error is used to parameter tune when building a classification tree; the corresponding predicted residuals are computed based on a one-step approximation of regression parameters; the labelled cases comprise one or more input variables and an output variable and the output variable has a distribution that is selected from the group consisting of a binomial distribution, a Poisson distribution, a gamma distribution and a negative binomial distribution; one or more other models are generated, other corresponding predicted residuals are computed for each of the one or more other models; and an optimal model for the labelled cases is selected from among the model and the one or more other models based on the k-fold R-square statistic that meets an evaluation criteria; the k folds have substantially a same size; an execution time of the computing is lower than another execution time of a corresponding computation of predicted residuals associated with said bypassed traditional repetitive model training-then-testing process.

In another aspect herein, a non-transitory computer readable storage medium is disclosed. The non-transitory computer readable storage medium stored program instructions which, when executed by a processor, causes the processor to perform a procedure that includes an acquisition, via a predictive analytics engine of a learning machine, of input data to be analyzed, the input data includes a plurality of labeled cases. The processor also trains a model, based on a parameter estimation procedure, by using the plurality of labelled cases. The processor then randomly divides the plurality of labelled cases into a number of folds (k folds). For each of the k folds, the processor computes a set of corresponding predicted residuals in the fold using an inverse transformation of ordinary residuals representative of a difference between the output values of the labelled cases in the fold and their estimated or fitted values, the corresponding predicted residuals being representative of a bypassed traditional repetitive model training-then-testing process. The processor then receives k sets of corresponding predicted residuals and determines a k-fold R-square statistic using all the members of the k sets of corresponding predicted residuals. Herein, the k-fold R-square statistic is indicative of a k-fold cross-validation error of the model.

In another aspect, a computer system is disclosed. The computer system comprises at least one processor which is configured to performs the steps of: acquiring, via a predictive analytics engine of a learning machine, input data to be analyzed, the input data comprising a plurality of labeled cases; training a model, based on a parameter estimation procedure, by using the plurality of labelled cases and randomly dividing the plurality of labelled cases into a number of folds (k folds). For each of the k folds, the processor computes a set of corresponding predicted residuals in the fold using an inverse transformation of residuals representative of a difference between the output values of the labelled cases in the fold and their estimated or fitted values, the corresponding predicted residuals being representative of a bypassed traditional repetitive model training-then-testing process. It receives k sets of corresponding predicted residuals and determines a k-fold R-square statistic using all the members of the k sets of corresponding predicted residuals, the k-fold R-square statistic being indicative of a k-fold cross-validation error of the model.

In one or more other aspects herein, computational resources do not impose a limit on the number of folds in a design, unlike in conventional k-fold cross-validation in which a number of folds is limited to, for example, 5 or 10. Thus, a larger number of folds can be included in the cross-validation design to improve on the statistical properties of required estimates. Further, an embodiment provides faster cross-validation than the standard approaches in large sample designs where the number of folds is large. For example, for linear models, the embodiment provides a method that is at least two times faster than traditional k-fold cross-validation for a moderate number of folds (e.g. 50). Another instance of the method can be as much as 300 times faster than traditional k-fold cross-validation, for a larger number of folds, e.g. 1000. In another example for generalized linear models, an embodiment provides a cross-validation method that is at least 6 times faster than traditional k-fold cross-validation for moderate number of folds and as much as 600 times faster than the old method when the number of folds is very large (e.g. 1000). In another example, a significantly simpler process if provided by the bypassing of repetitive model training-then-testing process as discussed hereinafter.

### BRIEF DESCRIPTION OF THE DRAWINGS

Certain novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented.

FIG. 2 depicts a block diagram of a data processing system in which illustrative embodiments may be implemented.

FIG. 3 depicts a block diagram of an application in which illustrative embodiments may be implemented.

FIG. 4 depicts a block diagram of a system in which illustrative embodiments may be implemented.

FIG. 5 depicts a flowchart of a generalized process in which illustrative embodiments may be implemented.

FIG. 6A depicts a chart in accordance with an illustrative embodiment.

FIG. 6B depicts a chart in accordance with an illustrative embodiment.

FIG. 7 illustrates a table showing results of a study in accordance with one illustrative embodiment.

FIG. 8A depicts a chart in accordance with an illustrative embodiment.

FIG. 8B depicts a chart in accordance with an illustrative embodiment.

FIG. 9 illustrates a table showing results of a study in accordance with one illustrative embodiment.

FIG. 10 depicts a flowchart of a general process in which illustrative embodiments may be implemented.

FIG. 11 depicts a flowchart of a process in accordance with one illustrative embodiment.

FIG. 12 depicts a flowchart of a process in accordance with one illustrative embodiment.

### DETAILED DESCRIPTION

The illustrative embodiments recognize that there is a need to improve the efficiency of cross-validation procedures. For example, standard cross-validation procedures, such as k-fold cross-validation, are computationally expensive in large sample designs due to a requirement for repetitive fitting of models. An exact number of model fitting steps in a cross-validation procedure equals the number of folds. Thus, for a system having a large number of folds, the procedure is computationally intensive and is potentially prohibitive. Moreover, the computational requirements, for k-fold cross-validation of generalized linear models, the fitting method being iterative, imposes an even greater limit on the number of folds to include in the analysis than for linear models. In part due to these computational difficulties, it is recommended to limit the number of folds to 5 or 10. The illustrative embodiments recognize that this limit, negatively impacts the accuracy level of a model evaluation process.

The illustrative embodiments described herein generally relate to k-fold cross-validation acceleration and test error determination for improved data analysis in the fields of data mining, predictive analytics, machine learning and business analytics. For example, machine-learning techniques (e.g., supervised statistical-learning techniques) may be used to generate a predictive model from a dataset that includes previously recorded observations of at least two variables. By partitioning the observations into at least one “training” dataset and at least one “test” dataset an operator can select a statistical-learning procedure and execute that procedure on the training dataset to generate a predictive subject model. The operator then tests the subject model on the test dataset to determine how well said subject model predicts values of targets data, relative to actual observations of the targets data.

Cross-validation involves deciding whether numerical results that quantify hypothesized relationships between variables of data, are acceptable as descriptions of the data. Generally, an error estimation or “evaluation of residual” for a subject model is made after training the subject model. In this process, a numerical estimate of the difference in the estimated responses and original responses is done. However, this only establishes how well said subject model performs on data used to train it. Due to potential underfitting or overfitting of the data by the subject model, an indication of how well said subject model can generalize unseen data set is not obtainable without a cross-validation. A type of cross-validation is the k-fold cross-validation. The illustrative embodiments however recognize that, k-fold cross-validation, which typically provides ample data for training the model and leaves ample data for validation, has significant shortfalls due to computationally expensive repetitive model fitting and an ensuing restriction on a number of folds that can be chosen for cross-validation, leaving little to no options for k-fold cross-validating big data using larger number of folds in the analysis.

Presently available systems and solutions do not address these needs or provide adequate solutions for these needs. The illustrative embodiments therefore recognize that by bypassing the repetitive fitting of linear and generalized linear models, computational requirements can be significantly reduced, fold number restrictions eliminated or substantially eliminated, statistical properties of estimates improved, and k-fold cross-validation timelines significantly accelerated as described hereinafter.

The invention thus generally addresses and solves the above-described problems and other problems related to determining a k-fold cross-validation error and accelerating k-fold cross-validation in the process.

An embodiment can be implemented as a software and/or hardware application. The application implementing an embodiment can be configured as a modification of a predictive analytic system, as a separate application that operates in conjunction with an existing predictive analytic system, a standalone application, or some combination thereof.

Particularly, some illustrative embodiments provide a method that determines a k-fold cross-validation error of a model through bypassing a traditional repetitive model training-then-testing process. The method includes acquiring, input data to be analyzed, the input data comprising a set of N labeled cases based on one or more input variables and an output variable. The model is then trained, based, for example, the OLS (ordinary least squares) method, using the set of N labelled cases. The set of N labelled cases are randomly divided into k folds of substantially the same size and for each of said k folds, a set of corresponding predicted residuals of the fold, indicative of the bypassing, are computed using an inverse transformation process that bypasses said traditional repetitive model training-then-testing process. The inverse transformation process includes transforming the ordinary residuals in the fold, which are the difference between each value of the output variable in the fold and its corresponding estimated or fitted value. An error is then computed based on the corresponding predicted residuals.

Another embodiment accelerates k-fold cross-validation due to the elimination of the repetitive model training-then-testing process otherwise conducted in a traditional k-Fold cross-validation, and aids in the selection of an optimal linear or generalized linear model.

In an embodiment, the computational cost of the accelerated k-fold cross-validation decreases exponentially to near zero seconds as the number of folds increases. In contrast, the computational cost of traditional k-fold cross-validation increases linearly with increase in the number of folds. Thus, large sample designs and big data where a need for speed is critical are more optimally handled with the accelerated k-fold cross-validation in comparison to traditional k-fold cross-validation. Further, the embodiment determines a model performance statistic directly from a single fit of the model on an entire data set, and as a result, providing a faster and easier method in comparison to traditional methods.

This manner of k-fold ross-validation where there are more than one observation per fold is unavailable in the presently available methods in the technological field of endeavor pertaining to predictive analytic platforms. A method of an embodiment described herein, when implemented to execute on a device or data processing system, comprises substantial advancement of the computational functionality of that device or data processing system in configuring the performance of a predictive analytic platform.

The illustrative embodiments are described with respect to certain types of learning machines 126 developing a predictive analytic model based on data records partitioned randomly into folds without restriction on the number of folds. The illustrative embodiments are also described with respect to other scenes, subjects, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

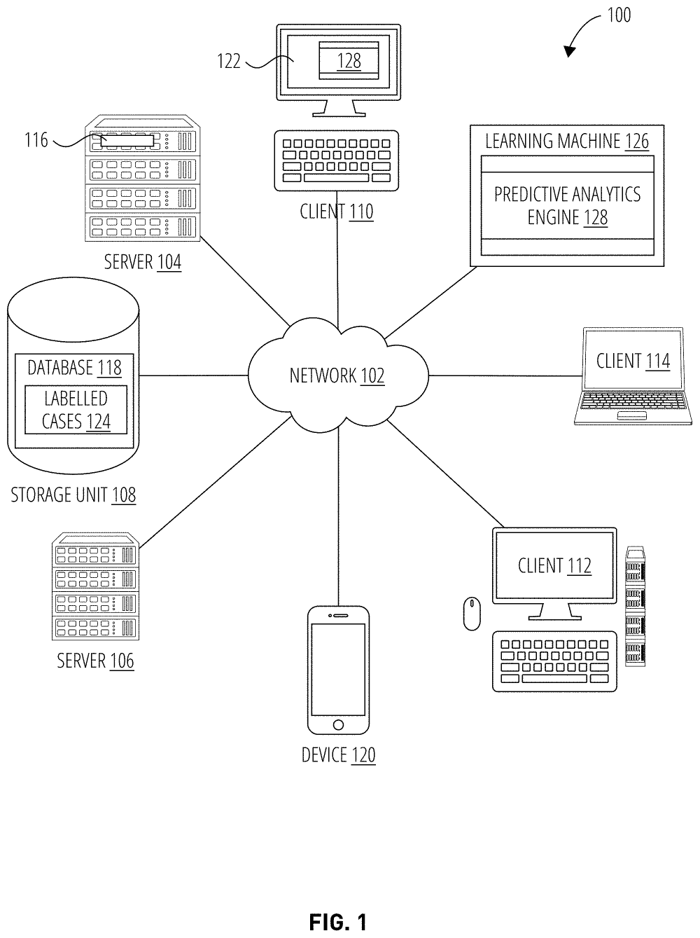

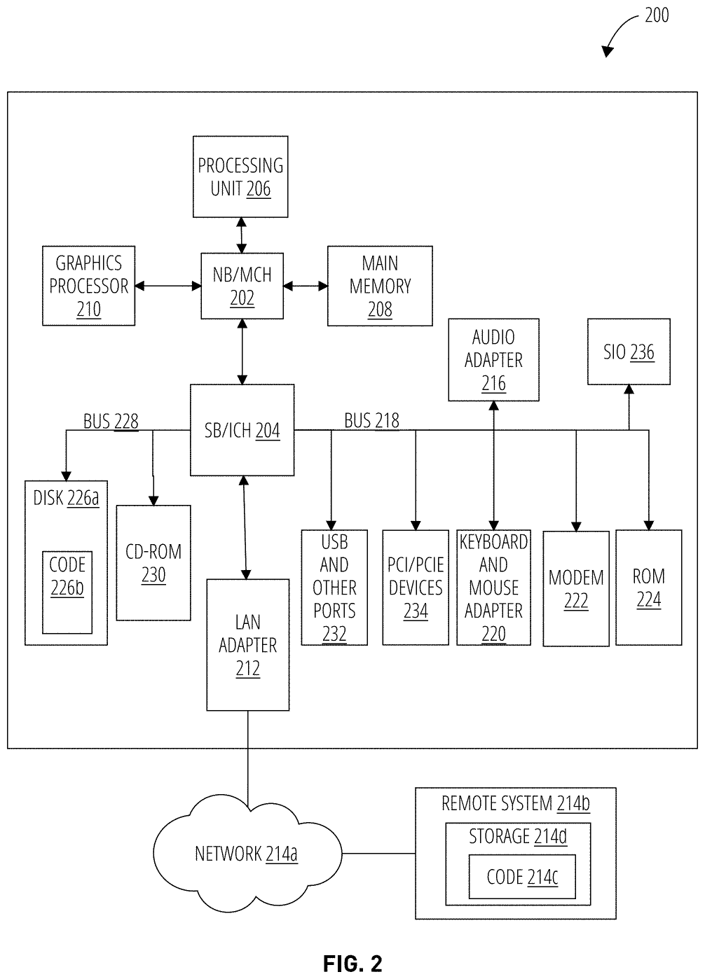

With reference to the figures and in particular with reference to FIG. 1 and FIG. 2, these figures are example diagrams of data processing environments in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Client 110, client 112, client 114 are also coupled to network 102. A data processing system, such as server 104 or server 106, or clients (client 110, client 112, client 114) may contain data and may have software applications or software tools executing thereon. Server 104 may include one or more GPUs (graphics processing units) for training one or more models.

Only as an example, and without implying any limitation to such architecture, FIG. 1 depicts certain components that are usable in an example implementation of an embodiment. For example, servers and clients are only examples and not to imply a limitation to a client-server architecture. As another example, an embodiment can be distributed across several data processing systems and a data network as shown, whereas another embodiment can be implemented on a single data processing system within the scope of the illustrative embodiments. Data processing systems (server 104, server 106, client 110, client 112, client 114) also represent example nodes in a cluster, partitions, and other configurations suitable for implementing an embodiment.

Device 120 is an example of a device described herein. For example, device 120 can take the form of a smartphone, a tablet computer, a laptop computer, client 110 in a stationary or a portable form, a wearable computing device, or any other suitable device. Any software application described as executing in another data processing system in FIG. 1 can be configured to execute in device 120 in a similar manner. Any data or information stored or produced in another data processing system in FIG. 1 can be configured to be stored or produced in device 120 in a similar manner.

Predictive analytics engine 128 may execute as part of client application 122, application 116 or on any data processing system herein. Predictive analytics engine 128 may also execute as a cloud service communicatively coupled to system services, hardware resources, or software elements described herein. Database 118 of storage unit 108 stores one or more sets of labelled cases 124 in repositories for computations herein.

Application 116 implements an embodiment described herein. Application 116 can use data from storage unit 108 for cross-validation. Application 116 can also obtain data from any client for cross-validation. Application 116 can also execute in any of data processing systems (server 104 or server 106, client 110, client 112, client 114), such as client application 122 in client 110 and need not execute in the same system as server 104.

Server 104, server 106, storage unit 108, client 110, client 112, client 114, device 120 may couple to network 102 using wired connections, wireless communication protocols, or other suitable data connectivity. Client 110, client 112 and client 114 may be, for example, personal computers or network computers.

In the depicted example, server 104 may provide data, such as boot files, operating system images, and applications to client 110, client 112, and client 114. Client 110, client 112 and client 114 may be clients to server 104 in this example. Client 110, client 112 and client 114 or some combination thereof, may include their own data, boot files, operating system images, and applications. Data processing environment 100 may include additional servers, clients, and other devices that are not shown. Server 104 includes an application 116 that may be configured to implement one or more of the functions described herein for cross-validation in accordance with one or more embodiments.

Server 106 includes a search engine configured to search trained models or databases in response to a query with respect to various embodiments. The data processing environment 100 may also include a dedicated learning machine 126 which comprises a predictive analytics engine 128. The dedicated learning machine 126 may be used for training a model in order to make predictions. The learning machine 126 may make predictions by applying input data to a predictive analytic model. It may learn to make predictions by constructing the predictive analytic model. It may construct the predictive analytic model by predictive analysis of example data. Various types of predictive analytic models may be constructed and employed by the learning machine 126 to make predictions. For example, the learning machine 126 may construct and employ predictive analytic models including a regression tree and a classification tree.

An operator of the learning machine 126 can include individuals, computer applications, and electronic devices. The operators may employ the predictive analytics engine 128 of the learning machine 126 to make predictions or decisions. An operator may desire that the predictive analytics engine 128 satisfy a predetermined evaluation criterion. A model is constructed based on predictive analysis of training data/labelled cases 124, the models is evaluated based on test data by bypassing the repetitive model training-then-testing process to obtain a model satisfying the predetermined evaluation criteria as described herein.

The data processing environment 100 may also be the Internet. Network 102 may represent a collection of networks and gateways that use the Transmission

Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service-oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as server 104, server 106, or client 110, client 112, client 114 in FIG. 1, or another type of device in which computer usable program code or instructions implementing the processes may be located for the illustrative embodiments.

Data processing system 200 is also representative of a data processing system or a configuration therein, such as device 120 in FIG. 1 in which computer usable program code or instructions implementing the processes of the illustrative embodiments may be located. Data processing system 200 is described as a computer only as an example, without being limited thereto. Implementations in the form of other devices, such as device 120 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to North Bridge and memory controller hub (NB/MCH) 202 through an accelerated graphics port (AGP) in certain implementations.

In the depicted example, local area network (LAN) adapter 212 is coupled to South Bridge and input/output (I/O) controller hub (SB/ICH) 204. Audio adapter 216, keyboard and mouse adapter 220, modem 222, read only memory (ROM) 224, universal serial bus (USB) and other ports 232, and PCl/PCIe devices 234 are coupled to South Bridge and input/output (I/O) controller hub (SB/ICH) 204 through bus 218. Hard disk drive (HDD) or solid-state drive (SSD) 226a and CD-ROM 230 are coupled to South Bridge and input/output (I/O) controller hub (SB/ICH) 204 through bus 228. PCl/PCIe devices 234 may include, for example, Ethernet adapters, add-in cards, and PC cards for notebook computers. PCI uses a card bus controller, while PCIe does not. Read only memory (ROM) 224 may be, for example, a flash binary input/output system (BIOS). Hard disk drive (HDD) or solid-state drive (SSD) 226a and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and input/output (I/O) controller hub (SB/ICH) 204 through bus 218.

Memories, such as main memory 208, read only memory (ROM) 224, or flash memory (not shown), are some examples of computer usable storage devices. Hard disk drive (HDD) or solid-state drive (SSD) 226a, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 116 and client application 122 in FIG. 1, are located on storage devices, such as in the form of codes 226b on Hard disk drive (HDD) or solid-state drive (SSD) 226a, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory (ROM) 224, or in one or more peripheral devices.

Furthermore, in one case, code 226b may be downloaded over network 214a from remote system 214b, where similar code 214c is stored on a storage device 214d in another case, code 226b may be downloaded over network 214a to remote system 214b, where downloaded code 214c is stored on a storage device 214d.

The hardware in FIG. 1 and FIG. 2 may vary depending on the implementation. Other internal hardware or peripheral devices, such as flash memory, equivalent non-volatile memory, or optical disk drives and the like, may be used in addition to or in place of the hardware depicted in FIG. 1 and FIG. 2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub (NB/MCH) 202. A processing unit may include one or more processors or CPUs.

The depicted examples in FIG. 1 and FIG. 2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and Hard disk drive (HDD) or solid-state drive (SSD) 226a is manifested as a virtualized instance of all or some portion of Hard disk drive (HDD) or solid-state drive (SSD) 226a that may be available in the host data processing system. The host data processing system in such cases is represented by data processing system 200.

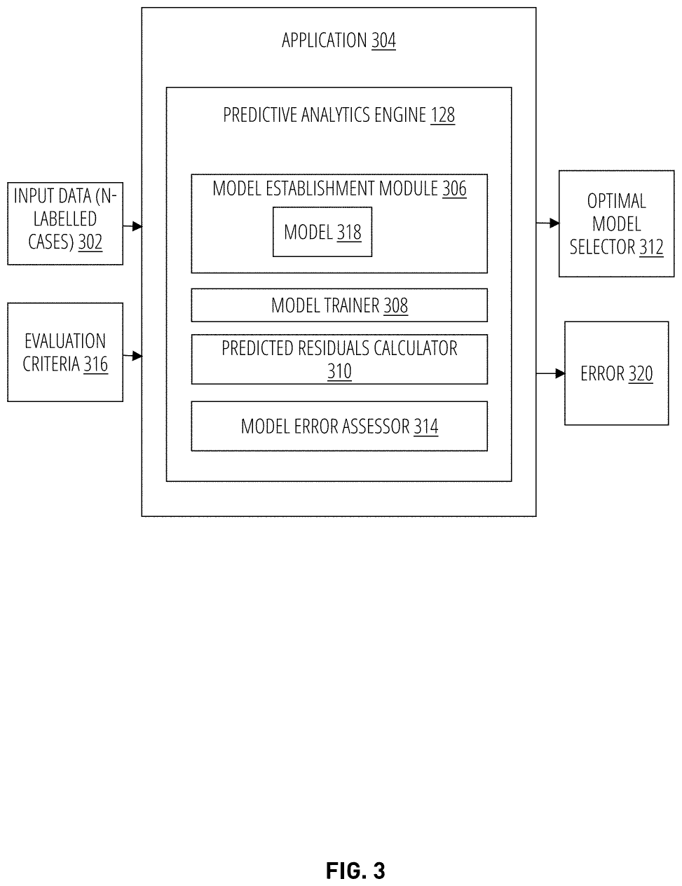

Turning now to FIG. 3, the figure shows an application 304 according to an illustrative embodiment. The application 304 may be embodied as client application 122 or application 116 or any other application of a data processing system 200. The application 304 includes and/or interacts with a predictive analytics engine 128 which comprises a model establishment module 306, a model trainer 308, a predicted residuals calculator 310 and a model error assessor 314. The components are functional elements that are functionally distinguishable from one another, and in an actual physical environment, may be incorporated into fewer or more components.

The model establishment module 306 receives or determines one or more independent variables based on a dataset to be analyzed. The dataset is or includes labelled cases 124. The model establishment module 306 establishes a model 318 showing a relationship between one or more independent variables and a dependent variable of the dataset. To achieve a plurality of models once the input data is entered, the model establishment module 306 could, for example, systematically select a model with one input variables, then a model with two input variables, and so on, for assessment by changing input variables in the models or adding or removing interaction terms in the mode . The model establishment module 306 may thus continue to establish a model 318 until an iteration terminating condition such as the evaluation criteria 316 is met. For example, the detection of error corresponding to local minima, the detection of error corresponding to global minima, or a predetermined number of iterations may be set as the iteration terminating condition.

The model trainer 308 trains model 318 using the input data 302. The input data 302 may comprise N labelled cases 124 and all N labelled cases 124 may be used in the training. The N labelled cases 124 are partitioned into a number of folds (k-folds). Upon training the model 318 on all N labelled cases 124, predicted residuals calculator 310 computes predicted residuals for each fold using an inverse transformation step as discussed hereinafter, in order to bypass a more computationally demanding repetitive model training-then-testing process of a traditional k-fold cross-validation. The traditional k-fold cross-validation is a general resampling technique that evaluates the performance of a statistical learning method by computing an average error (test error rate) to measure a model's ability to accurately predict responses on new observations. For linear models and generalized linear models the test error rate is expressed as an R-squared statistic and a deviance R-square statistic, respectively. Values of the R-square statistic and deviance R-square statistic typically range from 0 to 1. The smaller the test error rate the closer the R-square statistic is to 1 and the better is the performance of the model. Said traditional k-fold cross-validation process to determine the R-square statistic and deviance R-square statistic, collectively referred to herein as (deviance) R-square statistic, entails partitioning observations into k-folds, with one fold being held out as a test fold and the other folds(k−1 folds) being used as training folds. A fitting method is applied on all observations of the k−1 training folds with the test fold being held-out. This allows a set of predicted residuals corresponding to the held-out fold to be computed using a fit of the k−1 training folds. The fitting process is repeated for the other folds by sequentially holding each of the other k−1 folds as a test fold, all the remaining folds of the partitioning as training folds and computing a set of predicted residuals for the newly held-out fold. An error is averaged over all k trials to get total effectiveness of the fit of the model using all the observations. Thus, every data point gets to be in a test set exactly once and gets to be in a training set k−1 times thereby significantly reducing bias as most of the data are used for fitting/training, particularly if there many folds in the design. The repetitive fitting/training and testing of the folds is referred to herein as traditional k-fold cross-validation and is known to be computationally expensive and exceptionally slow as the number of folds increases for large sample (big data) applications. Thus, it can be seen that as the number of folds increases, a method to bypass the traditional k-fold cross-validation is desired.

The new methods described herein sidesteps the repetitive model fitting with a single model fit on all the observations. The folded residuals, also referred to herein as predicted residuals, are deduced from the single fit and are combined to obtain the desired k-fold R-squared statistic.

The model error assessor 314 of FIG. 3 is configured to calculate the error of the model 318 established by the model establishment module 306. In some illustrative embodiments, the calculation of the error produces an R-square value indicative of the error of the model. In some embodiments, an optimal model selector 312 may be included. The optimal model selector 312 determines an optimal model for the data based on the output of the model error assessor 314. Specifically, if the iteration termination condition is the detection of error corresponding to local minima, the optimal model selector 312 determines a model having error corresponding to local minima as the optimal statistical model. If the iteration termination condition is the detection of error corresponding to global minima, the optimal model selector 312 determines a model having error corresponding to global minima as the optimal model. If the iteration termination condition is a predetermined number of iterations, the optimal model selector 312 determines a model with the least error as the optimal statistical model. In an illustrative embodiment in which an optimal model is not selected, an error 320 of a model can be output.

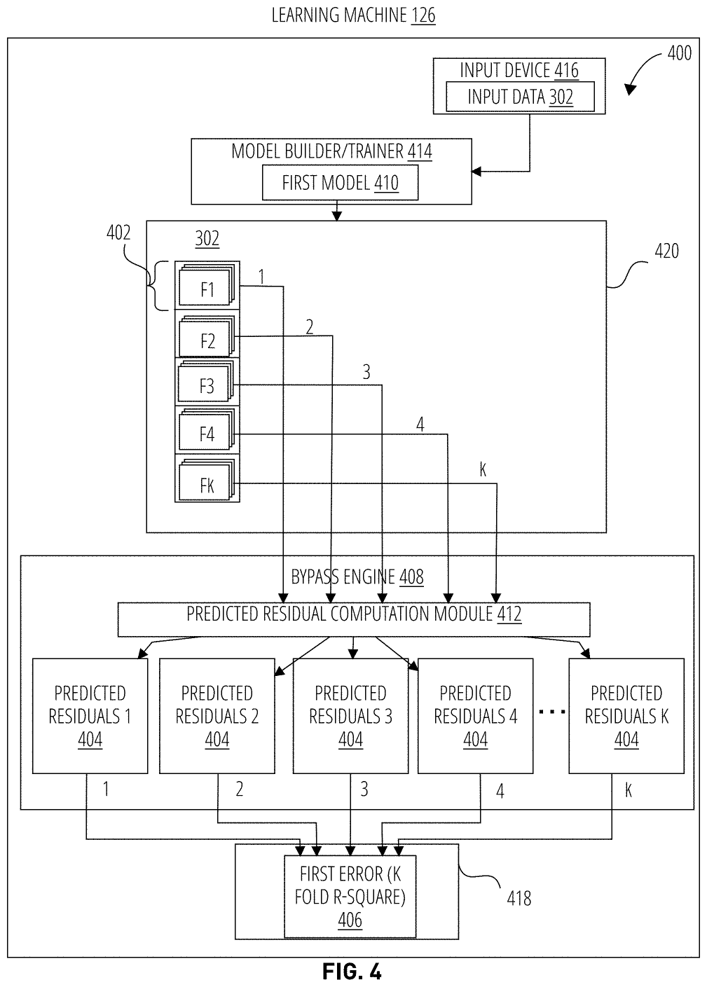

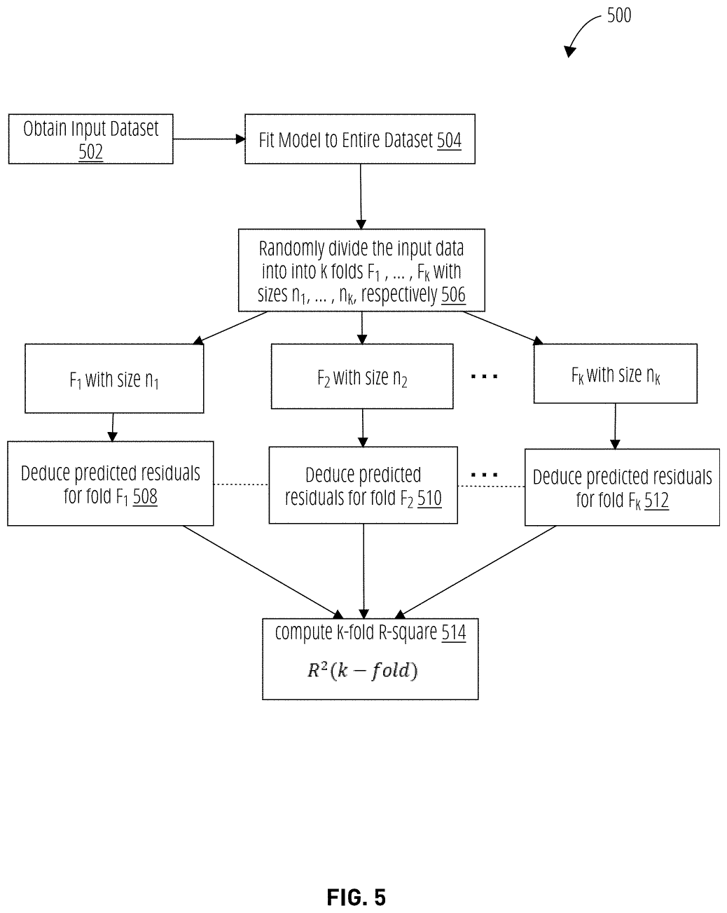

Turning now to FIG. 4, this example depicts a block diagram of an illustrative configuration of an accelerated k-fold cross-validation system 400. The accelerated k-fold cross-validation system 400 includes a learning machine 126, which may also include a predictive analytics engine 128 (not shown) and may be embodied in the form of any combinations of a client and a server in data processing environment 100. The accelerated k-fold cross-validation is described in conjunction with FIG. 5 which illustrates steps of an accelerated k-fold cross-validation process. The accelerated k-fold cross-validation system 400 includes an input device 416 through which measurements of a system to be evaluated are input as input data 302. The input data comprises input and output variables and the input data 302 are obtained (step 502, FIG. 5) and used by a model builder/trainer 414 to build and train/fit one or more models such as first model 410 to the input data 302 (step 504). The training may be done using a parameter estimation procedure such as an ordinary least-squares (OLS) method. A partitioning engine 420 randomly partitions or divides the input data 302 into k folds F₁, . . . , , Fₖ with sizes n₁, . . . , nₖ, respectively, step 506. The partitioning engine 420 then assigns one fold as a test fold 402, and each of the other folds as training folds. However, unlike traditional k-fold cross-validation, it is not necessary to combine remaining folds into combined training folds for training since the traditional repetitive model training-then-testing process is bypassed. Thus, for each fold, a bypass engine 408 having an predicted residual computation module 412 is employed to compute predicted residuals 404. Said predicted residuals 404 are representative of an inverse transformation of ordinary residuals in the folds, which are the difference between each value of the output variable in the fold and its corresponding estimated or fitted value. This is depicted by step 508—step 512. The step of determining the predicted residuals 404 is explained in more detail hereinafter. Upon obtaining the predicted residuals 404 for all folds, a k-fold R-square statistic indicative of an error of the model is obtained based on all the predicted residuals 404.

The accelerated k-fold cross-validation will now be described in more detail with respect to linear models and generalized linear models. Herein, input data comprises one or more input variables and an output variable, and the output variable may have a distribution such as a binomial distribution, a Poisson distribution, a gamma distribution, or a negative binomial distribution. The accelerated k-fold cross-validation process is derived from a generalization the deleted residuals and PRESS (predicted residual error sum of squares) statistic in classical regression models, which is a model validation method used to assess a model's predictive ability or to compare regression models. More specifically, classical regression, shows that least squares (OLS) estimates from n−1 observations can be expressed in terms of the results of training the LS method on all n observations. This can be generalized herein for a case where more than one observation is excluded from the regression analysis. Thus, assume that the sample has been randomly partitioned into k folds, Fⱼ, j=1, . . . , k. Also let nⱼ be the number of observations in fold Fⱼ so that n=Σnⱼ.

Accelerated k-fold Cross-Validation for Linear Models

The deleted residuals and PRESS statistic can be generalized to cases where more than one observation is omitted from the analysis. Specifically, the regression results based on all the observations but those in fold Fⱼ are computable from the results of training the LS method on all n observations. The equivalent deleted residuals, referred to herein as predicted residuals 404 for the observations in fold Fⱼ are obtained as the components of an nⱼ×1 vector given by

e₍ⱼ₎=(Iⱼ−X₍ⱼ₎(X^{T}X)⁻¹X₍ⱼ₎^{T})⁻¹(Yⱼ−Ŷⱼ)=(Iⱼ−Hⱼ)⁻¹ (Yⱼ−Ŷⱼ)

wherein Iⱼ is the nⱼ×nⱼ identity matrix; X₍ⱼ₎ is an nⱼ×p matrix made of the rows of the design matrix X in fold Fⱼ; Yⱼ is an nⱼ×1 vector of response values in fold Fⱼ; Ŷⱼ is an nⱼ×1 vector of estimated values for the response values in fold Fⱼ based on model fit to all observations. Thus, Yⱼ-Ŷⱼ is vector of ordinary residuals in in fold Fⱼ. The above formula shows that the predicted residuals corresponding to a fold are obtained as an inverse transformation of the ordinary residuals in that fold. In addition, the equivalent PRESS statistic is given as

$$SSE ( k - fold ) = {\sum }_{j = 1}^{k} S S E ( {F}_{j} )$$

wherein SSE (Fⱼ) is the fold contribution to the overall predicted residuals sum of squares, and is given as

SSE(Fⱼ)=e₍ⱼ₎^{T}e₍ⱼ₎

It follows then, that k-fold R-squared statistic is obtained as

$${R}^{2} ( k - fold ) = 1 - \frac{SSE ( k - fold )}{S S T}$$

Based on these results, the accelerated k-fold cross-validation is performed in the following steps.
(1) Fit the regression model on all observations.
(2) Randomly divide the set of observations into k folds of approximately equal size.
   For each fold Fⱼ, invert Iⱼ−Hⱼ and compute the predicted residuals, e₍ⱼ₎, as an inverse transformation of the ordinary residuals in that fold and calculate the k-fold R-square statistic as

$${R}^{2} ( k - fold ) = 1 - \frac{SSE ( k - fold )}{S S T} where$$

$$SSE ( k - fold ) = {\sum }_{j = 1}^{k} {e}_{( j )}^{T} {e}_{( j )}$$

The k-fold R-square statistic calculated using the accelerated algorithm is thus mathematically equivalent, as shown in the examples herein, to the one obtained using the traditional k-fold cross-validation. In addition, if the number of folds equals the sample size (there is exactly on observation in each of the fold) then the k-fold r-squared statistic is exactly the same as the classical R-square predict statistic.
Thus, the centerpiece of the algorithm is the inversion of the following matrices

Iⱼ−HⱼIⱼ−X₍ⱼ₎ (X^{T}X)⁻¹X₍ⱼ₎^{T}, j=1, . . . , k

where the matrix (X^{T} X)⁻¹ is the unscaled variance-covariance matrix of the parameter estimates based on the model fit to all observations. Thus, this matrix is readily available after step (1) of the above algorithm is completed. The numerical complexity for the inversion of the matrix Iⱼ−Hⱼ is discussed hereinafter.
Accelerated k-Fold Cross-Validation for Generalized Linear Models

For generalized linear models, the statistical learning method is the iterative reweighted least squares (IRLS) algorithm which applies the OLS algorithm multiple times iteratively.

Therefore, IRLS may be comparatively more computationally intensive than LS. In addition, because of the iterative nature of the IRLS algorithm, it may be difficult to explicitly deduce or compute the regression results based on all the observations excluding those in fold Fⱼ from the regression results based on all n observations. It is, however, possible to approximate the parameter estimates and the deviance of the model based on all the observations excluding those in fold Fⱼ from the regression results that used all n observations. This involves a one “one-step” approximation where the parameter estimates of the regression that uses all observations excluding those in the left-out fold are obtained after taking just one step of the IRLS algorithm in which the parameter estimates of the regression that uses all n observations are used as the initial estimates. Herein, let X be the design matrix for all data, \hat{β} the vector of regression parameters after fitting all data; W is an n×n diagonal matrix of the generalized linear model internal weights after fitting all data; X₍ⱼ₎ is an nⱼ×p matrix containing the rows of the design matrix X in fold Fⱼ; rₚⱼ is an nⱼ×1 vector of Pearson residuals in fold Fⱼ based on model fit to all data; W₍ⱼ₎ is an nⱼ×nⱼ diagonal matrix of the internal weights based on the observations in fold Fⱼ.

The one-step approximation of the regression parameters vector, β₍ⱼ₎, based on the model fit excluding the observation in fold Fⱼ is expressed as

\hat{β} ₍ⱼ₎≈\hat{β} −(X^{T}WX)⁻¹X₍ⱼ₎^{T}Wⱼ^{1/2}(Iⱼ−Hⱼ)⁻¹rₚⱼ

where

Hⱼ=W₍ⱼ₎^{1/2}X₍ⱼ₎(X^{T}WX)⁻¹X₍ⱼ₎^{T}W₍ⱼ₎^{1/2}

and rₚⱼ are the Pearson's residuals in fold Fⱼ.
The above formula shows that the parameter estimates of the regression that uses all observations excluding those in the left-out fold are approximately the difference between the regression estimates that uses all n observations and an inverse transformation of the Pearson residuals in the left-out fold.
The predicted values of the observations in fold Fⱼ based on the model fit excluding the observations in fold Fⱼ can then be obtained as \hat{μ} ₍ⱼ₎=g⁻¹(X₍ⱼ₎\hat{β} ₍ⱼ₎), where g is the generalized linear model link function.
The predicted deviance residuals, r_{D,j,l}, for fold Fⱼ are calculated based on the nⱼ×1 vector \hat{μ} ₍ⱼ₎. More specifically, r_{D,j,l}=sign(yₗ−\hat{μ} ₍ⱼ₎ₗ)dₗ, where dₗ is given by

dₗ={square root over (2{log[f(yₗ; yₗ)]−log[f(yₗ; \hat{μ} ₍ⱼ₎ₗ)]})}, l=1, . . . , nⱼ

and f (yᵢ; μᵢ) is the probability density function of yᵢ.

Using the above notations, the accelerated k-fold cross-validation algorithm for generalized linear model is performed in the following steps.
(1) Fit the generalized linear model on all observations.
(2) Randomly divide the set of observations into k folds of approximately equal size.
(3) For each fold Fⱼ, invert Iⱼ−Hⱼ and obtain \hat{β} ₍ⱼ₎ as the difference between the estimates of the fitted model in step (1) and the inverse transformation of the Pearson's residuals; calculate, \hat{μ} ₍ⱼ₎, the predicted response values in the fold, and the predicted deviance residuals, r_{Dj,l} as given above.
(4) Calculate the k-fold deviance R-square statistic as

$${R}^{2} ( k - fold ) = 1 - \frac{{D}_{E} ( k - fold )}{{D}_{T}} where$$

$${D}_{E} ( k - fold ) = {\sum }_{j = 1}^{k} {\sum }_{l ∈ {F}_{j}} {r}_{D j , l}^{2} and$$

$${D}_{T} = {\sum }_{i = 1}^{n} 2 \{ log [ f ( {y}_{i} ; {y}_{i} ) ] - log [ f ( {y}_{i} ; \overline{y} ) ] \}$$

The deviance R-square statistic calculated in this manner is not mathematically identical to the one obtained using the traditional k-fold cross-validation. In large sample designs, however, the two methods yield statistics that are approximately equivalent. In other words, the two methods are asymptotically equivalent. Further, the centerpiece of this algorithm is the inversion of the matrices

Iⱼ−Hⱼ32 Iⱼ−W₍ⱼ₎^{1/2}X₍ⱼ₎(X^{T}WX)⁻¹X₍ⱼ₎^{T}W₍ⱼ₎^{1/2}, j=1, . . . , k.

where the matrix (X^{T}WX)⁻¹ is the variance-covariance matrix of the parameter estimates based on the model fit to all observations. Thus, this matrix is readily available after step (1) of the above algorithm is completed. The numerical complexity for the inversion of the matrix Iⱼ−Hⱼ is discussed hereinafter.

### Numerical Features

The centerpiece of the accelerated k-fold cross-validation process for linear regression models is the inversion of the matrices Iⱼ−Hⱼ=Iⱼ−X₍ⱼ₎(X^{T}X)⁻¹X₍ⱼ₎^{t}, j=1, . . . , k.

In the above expression, it was noted that Iⱼ is the nⱼ×nⱼ identity matrix and X₍ⱼ₎ is an nⱼ×p matrix containing the rows of the design matrix X in fold Fⱼ. In addition, the matrix (X^{T}X)⁻¹ is the unscaled variance-covariance matrix of the estimated parameters in the linear regression based on all observations. Therefore, this matrix is readily available without any additional calculations.

The numerical complexity for inverting Iⱼ−Hⱼ is directly related to the size of fold Fⱼ, nⱼ, because Iⱼ−Hⱼ is an nⱼ×nⱼ symmetric matrix. As the number of folds increases, however, the size of each fold decreases and, therefore, inverting the ensuing matrices Iⱼ−Hⱼ becomes computationally less challenging. Particularly, if the number of folds equals the sample size (k=n) then there is only a single observation in each fold. Consequently, inverting the matrix Iⱼ−Hⱼ amounts to inverting a scalar, which is a trivial task.

On the other hand, as the number of folds decreases the size of each fold increases and inverting the resulting matrices Iⱼ−Hⱼ becomes more demanding. Particularly, if there are only two folds in the design (k=2) then the sizes of the folds are approximately n/2. Thus, if n is large, inverting the matrices Iⱼ−Hⱼ can be computationally expensive.

In addition, using an algebraic transformation, the dimension of the inversion problem can be reduced in some cases. More specifically, by the Sherman-Morrison-Woodbury theorem,

(Iⱼ−Hⱼ)⁻¹=Iⱼ+X₍ⱼ₎(X^{T} X−X₍ⱼ₎^{T}X₍ⱼ₎)⁻¹X₍ⱼ₎^{T}

In this re-expression of the matrix (Iⱼ−Hⱼ)⁻¹, the matrix to invert is X^{T}X−X₍ⱼ₎^{T}X₍ⱼ₎ which is a p×p symmetric matrix. Thus, if the number of predictors, p, in the model is much less than the size of the folds, it is computationally more advantageous to invert Iⱼ−Hⱼ through the above expression.

These are also valid for generalized linear models. For those models, the centerpiece of the new k-fold validation algorithm is the inversion of the matrices

Iⱼ−Hⱼ=Iⱼ−W₍ⱼ₎^{1/2}X₍ⱼ₎(X^{T}WX)⁻¹X₍ⱼ₎^{T}W₍ⱼ₎^{1/2}, j=1, . . . , k

Thus, in large sample designs where there are many folds the accelerated k-fold cross-validation process is a significantly better alternative to the traditional k-fold cross-validation process for a computer system. As the number of folds increases, the faster the accelerated k-fold cross-validation process becomes. The traditional k-fold cross-validation process, however, becomes more appropriate when the number of folds is small as shown in the example charts herein.

### Statistical Features

The number of folds in a k-fold cross-validation design determines the accuracy and precision levels of the estimated test error rate. The more folds in a k-fold validation design the more accurate the estimated test error rate is because the predicted residuals are based on many observations in the training sets. This estimate is, however, less precise because the more folds in the designs, the higher the (positive) correlations among the predicted residuals are.

On the other hand, the fewer the folds in the design are the more precise the estimate is because the correlation among the predicted residuals are lower. The resulting estimate, however, is less accurate because there are less observations in the training sets.

Thus, given a sample of size n, the k-fold cross-validation design with as many folds as observations yields the most accurate estimated test error rate, but to a great detriment of precision. At the other extreme, the k-fold cross-validation design with only two folds provides the most precise estimate, but to a great detriment of accuracy. The recommended middle ground that also considers the computational cost of the traditional k-fold cross-validation method is to limit the number of folds to 5 or 10. As a result, adopting this approach may yield estimates that have great precision levels, but that are somewhat off target.

Since the accelerated k-fold cross-validation method is not computationally constrained by a larger number of folds in the designs, the recommended number of folds can be increased to strike a better balance between accuracy and precision. In larger sample designs, particularly, the number of folds can be increased to improve upon the accuracy level of estimates while maintaining a safe precision level. For example, if the sample size is 10,000 then the accelerated k-fold cross-validation method can be used with 100 folds to improve the accuracy of estimates without sacrificing precision. The number of observations in each fold is 100 so that the folded residuals will be based on 9900 observations. As a result, the estimate will be accurate. In addition, the number of folds is not so excessive, relative to the number observations, that it greatly impedes the precision level.

Thus, the conventional setting of 5 or 10 folds has some statistical merit but it is also based on the traditional k-fold cross-validation method and has computational limitations when many folds are in the design. The new method overcomes these limitations; therefore, the number of folds can be increased to improve the statistical properties of the estimates.

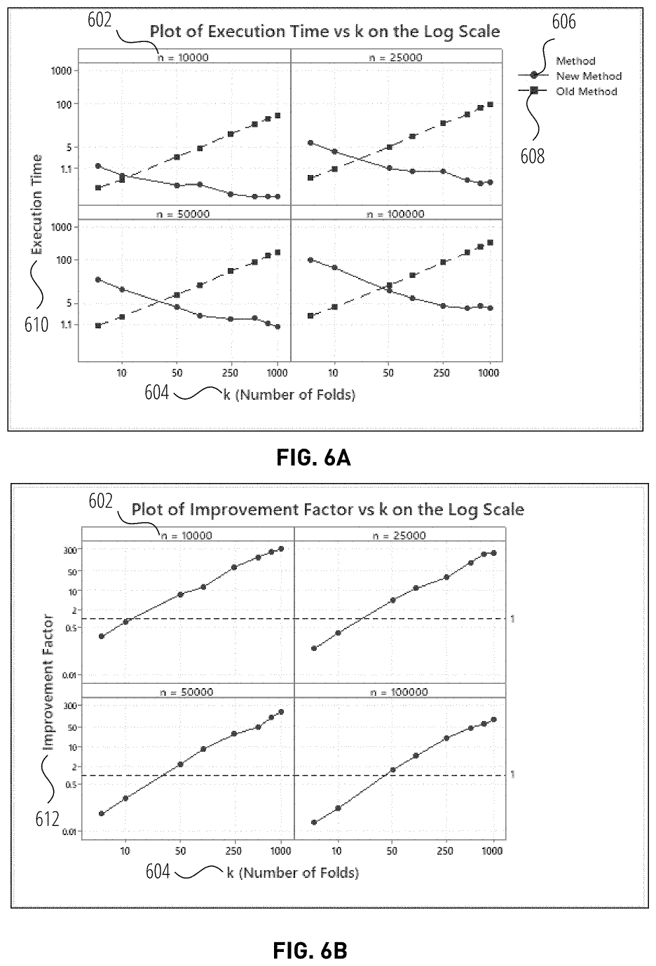

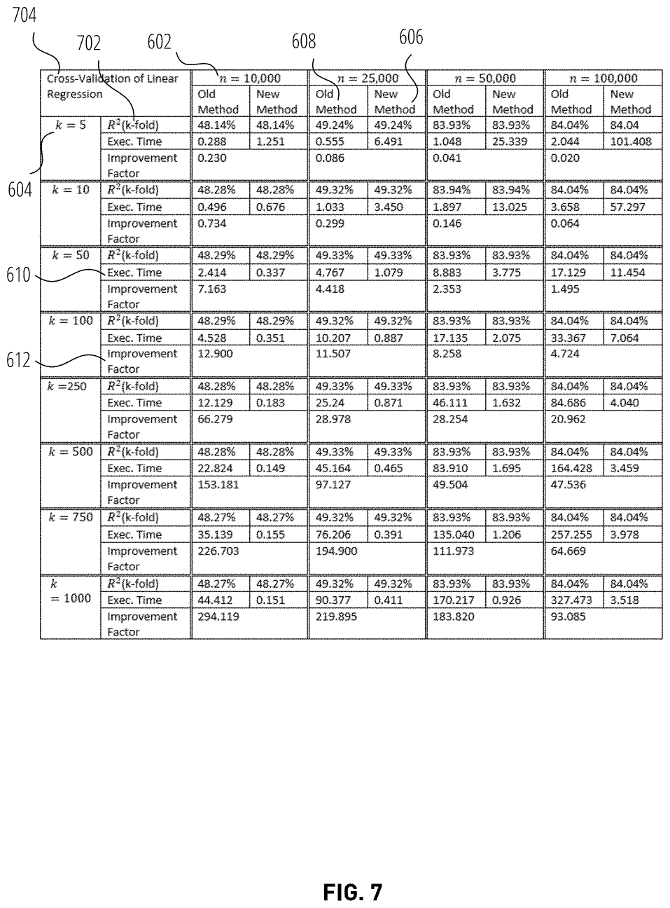

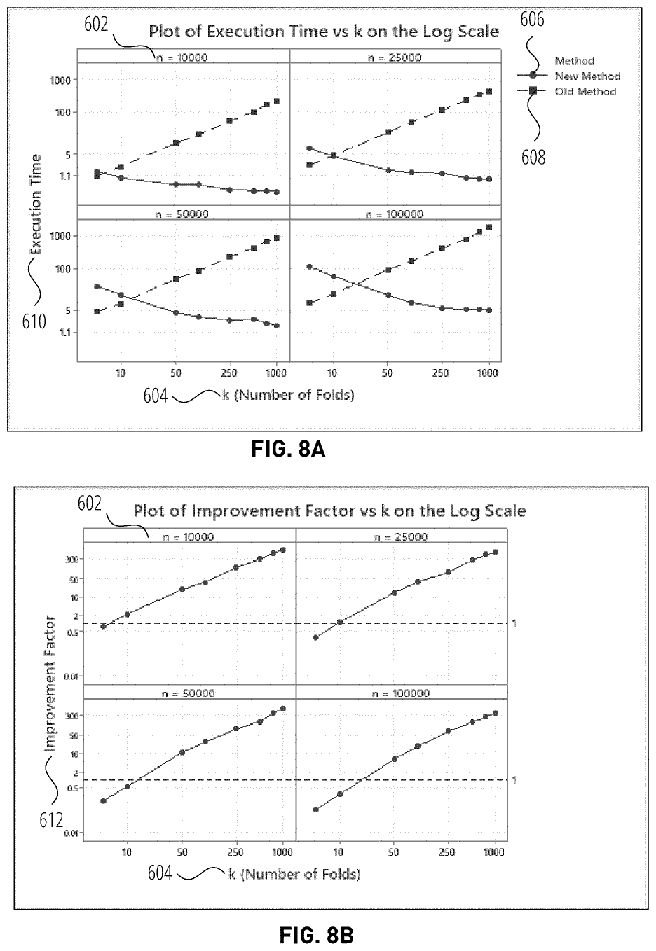

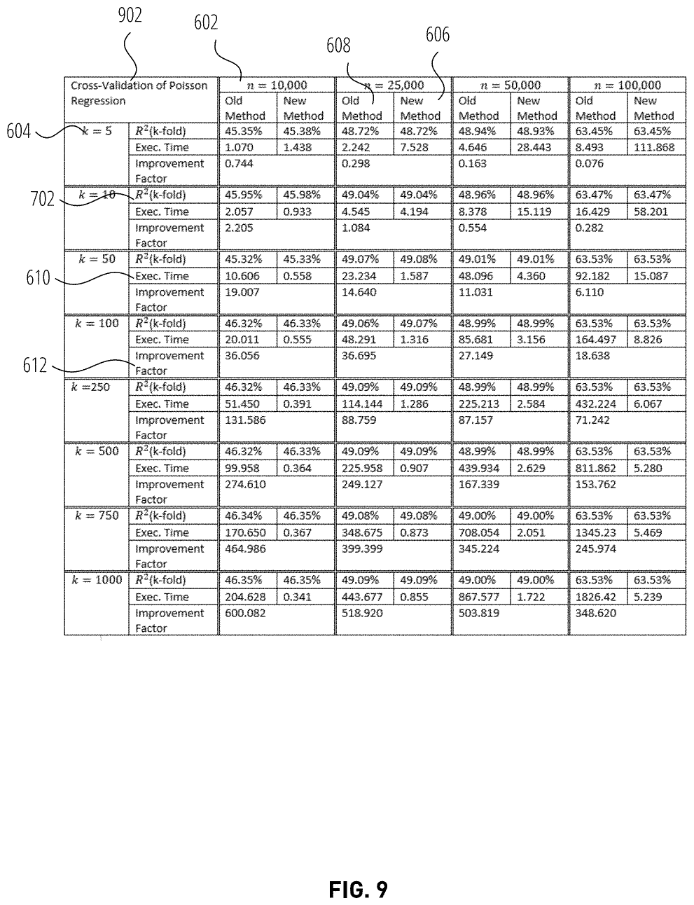

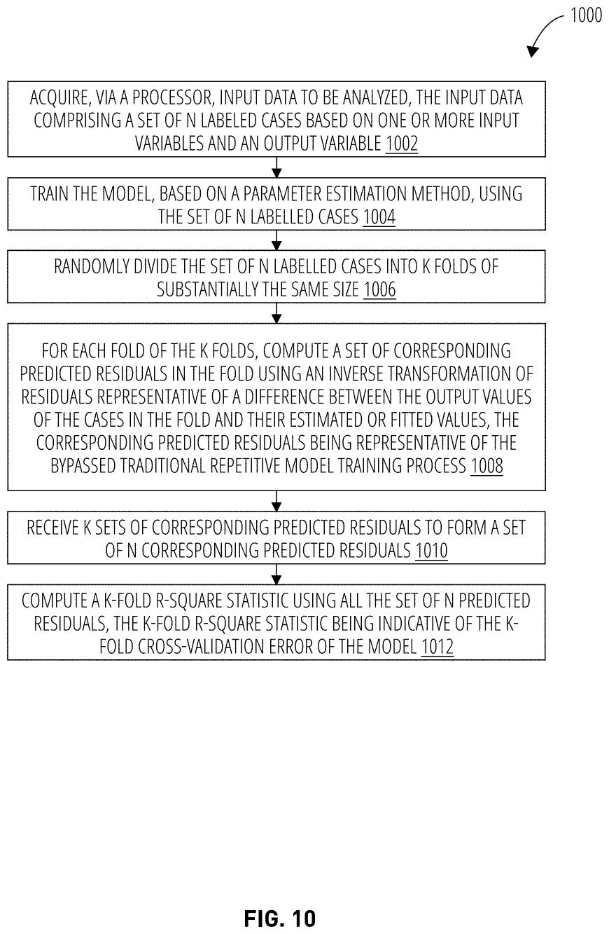

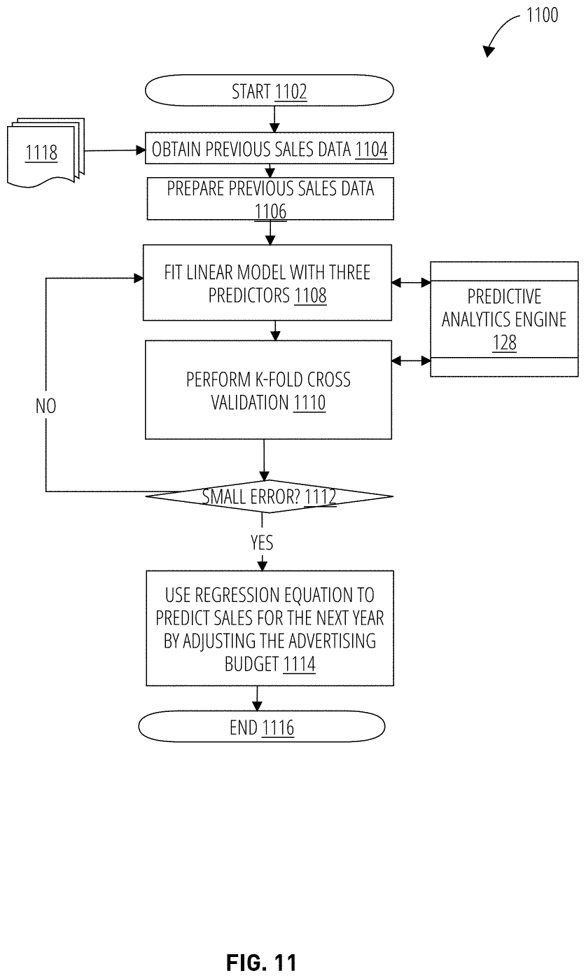

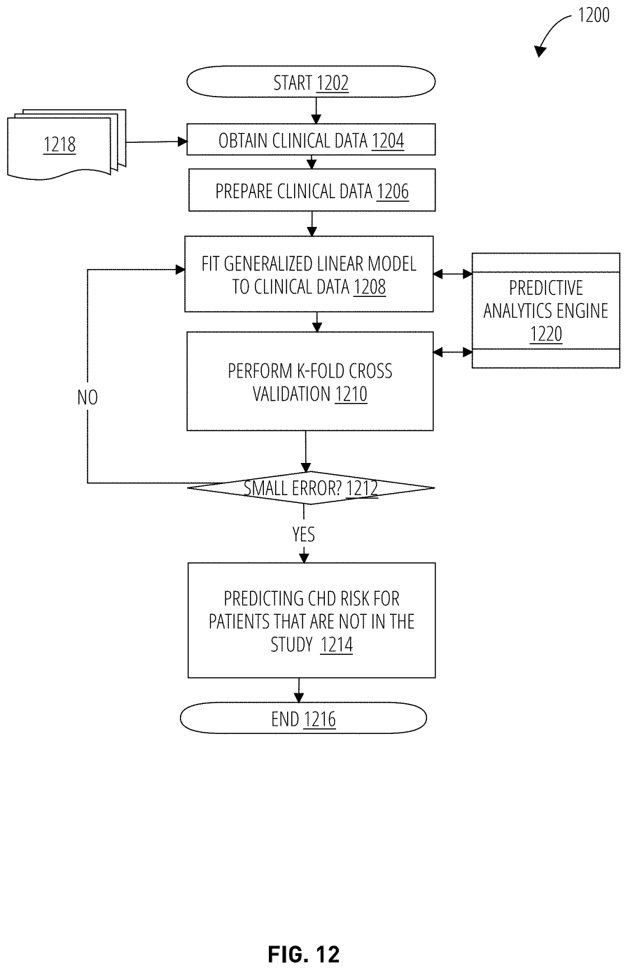

Simulation studies comparing performances of traditional k-fold cross-validation and accelerated k-fold cross-validation will now be discussed in conjunction with FIG. 6A, FIG. 6B, FIG. 7, FIG. 8A, FIG. 8B, and FIG. 9. The figures represent studies applied to linear models and generalized linear models wherein FIG. 6A, FIG. 6B and FIG. 7 correspond to cross-validation of linear regression models 704 while FIG. 8A, FIG. 8B and FIG. 9 correspond to cross-validation of Poisson regression models as an example of a generalized linear model 902. For each type of model, large data sets with sizes n=10000, 25000, 50000, 100000 (size 602) are simulated. Each data set comprises a randomly generated response variable and p predictor variables where p is chosen to be moderately large. In both cases, p=100.

For each data set, a model is fitted, and the model is evaluated by applying the traditional k-fold cross-validation 608 and the accelerated k-fold cross-validation 606. The number of folds k 604 in each design includes small, moderate and large to very large values of k where k=5, 10, 50, 100, 250, 500, 750,1000, (with 50 and 100 being moderate, for example) and is configured to ascertain the impact of the number of test folds 402 on the computational cost. For each data set, folds of equal sizes are randomly generated based upon the number of folds k 604 and the sample size 602. The random generators for the samples and the folds are seeded so that the results can be replicated.

For each study, a k-fold R-square statistic 702 calculated by each of the two k-fold cross-validation procedures is reported and their execution time 610 in seconds is computed. An improvement factor 612 of the accelerated k-fold cross-validation 606 over the traditional k-fold cross-validation 608 is also computed and reported, thus illustrating how many times faster the accelerated k-fold cross-validation is relative to the traditional k-fold cross-validation. It is calculated as the ratio of the old method execution time over the new method execution time in each experiment. For example, if the improvement factor is 2 then the new method (accelerated k-fold cross-validation) is twice as fast as the old method (traditional k-fold cross-validation). The k-fold R-square statistics are also reported for comparison. It can be seen that the k-fold R-square statistics for the two procedures are mathematically equivalent for linear models, and that they are approximately equivalent for generalized linear models.

With reference to FIG. 6A and FIG. 6B, the figures depict a plot of execution time 610 against number of folds k 604 on the log scale and improvement factor 612 against number of folds k 604 on the log scale. An ordinary least squares (OLS) fitting method is used, and the response and predictor samples are generated from the normal distribution. Results are shown in the table of FIG. 7.

The study shows that accelerated k-fold cross-validation 606 is faster than the traditional k-fold cross-validation 608 in large sample designs where the number of folds, k, is moderate, large or very large. FIG. 6A illustrates that the computational cost for the traditional k-fold cross-validation 608 increases linearly with the number of folds k 604. On the other hand, the computational cost for the accelerated k-fold cross-validation 606, decreases exponentially to near 0 seconds as the number of folds k 604 increases to the sample size. Further, FIG. 6B shows that the accelerated k-fold cross-validation 606 method is approximately at least twice faster than the traditional k-fold cross-validation 608 method in designs where the number of folds is moderate; and as much as 300 times faster than the traditional k-fold cross-validation 608 when there is a very large number (e.g. 1000) of folds in the design.

In a further analysis, when the number of folds is small, however, the traditional k-fold cross-validation 608 performs somewhat faster than the accelerated k-fold cross-validation 606. This is expected since the traditional k-fold cross-validation 608 requires the model to be refitted the same number of times as the number of folds. Thus, a higher number of folds improves the execution speed of the accelerated k-fold cross-validation and a lower number of folds improves the execution speed of the traditional k-fold cross-validation 608. Moreover, FIG. 6A shows that the plotted lines cross when the number of folds k 604 is in the interval (10, 50). Based on this, a decision to switch between the two procedures can be made to keep computational costs low.

In another non-limiting study, an example of a generalized linear model, namely the Poisson regression model, is used. Other models such as the Binomial, Bernouli, Gamma and Negative Binomial models can also be used. The fitting method is the IRLS algorithm and for each experiment a response was generated from a Poisson distribution and the 100 predictor samples from the normal distributions. FIG. 8A and FIG. 8B show graphical results of the study, with FIG. 9 showing corresponding tabulated data. Similarly, to results from the cross-validation of linear regression models 704, the cross-validation of Poisson regression models 902 exhibits the comparable patterns and trends. For this model, however, the computational costs for the traditional k-fold cross-validation are much higher because the fitting method relies on an iterative algorithm. When the number of folds k 604 is moderate (e.g. 50), the minimum improvement factor of the accelerated k-fold cross-validation over the traditional k-fold cross-validation is about 6. The improvement factor can be as much as 600 when the number of folds k 604 is large. Therefore, the accelerated k-fold cross-validation is at least 6 times faster and can be as much as 600 times faster.

Further, even though the accelerated k-fold cross-validation for generalized linear models is based on an approximation, the corresponding k-fold Deviance R-square statistics 702 (FIG. 9) are almost identical to those calculated using the traditional k-fold cross-validation even when the number of folds is small. As in the linear model, it is cost efficient to use the accelerated k-fold cross-validation when the number fold is moderate or large and the sample size 602 exceeds 200 (n>200).

Thus, the accelerated k-fold cross-validation can be described generally in relation to both linear and generalized linear models by the steps of process 1000 which begins at Step 1002 wherein the process 1000 acquires, via a processor, input data to be analyzed, the input data comprising a set of N labeled cases based on one or more input variables and an output variable. Subsequently, in Step 1004, process 1000 fits the model on the set of N labelled cases, using a trainer which is based on, for example, the OLS (ordinary least squares) or IRLS method (iterative reweighted least squares). In Step 1006, process 1000 randomly divides the set of N labelled cases into k folds of substantially the same size. In Step 1008, process 1000 computes, for each fold of the k folds, a set of corresponding predicted residuals in the fold using an inverse transformation of residuals that are representative of a difference between the output values of the cases in the fold and their estimated or fitted values, the corresponding predicted residuals being representative of the bypassed traditional repetitive model training process. Further, for generalized linear models, Step 1008 includes a one-step approximation. In Step 1010, process 1000 receives k sets of corresponding predicted residuals (or deviance residuals) to form a set of N corresponding predicted residuals. In Step 1012, process 1000 computes a k-fold R-square statistic (or k-fold deviance R-square statistic) using all the set of N predicted residuals, the k-fold R-square statistic being indicative of the k-fold cross-validation error of the model.

Example uses in accordance with some illustrative embodiments will now be described. A main goal of a data collection task is to develop models for predictive purposes. When a model 318 is developed it is customary to provide some goodness-of-fit (or equivalently lack-of-fit) statistics to measure the quality of the fit. These statistics, unfortunately, are always based on the data used to fit the model (training data set). As a result, these statistics do not provide useful information about the accuracy of the model in predicting response values based on new predictor values. Ideally, an investigator would collect a training data set for the purpose of fitting a model and a test data set for the purpose of measuring the model's ability to predict responses. However, such data set is usually not available. As a result, resampling techniques such as the k-fold cross-validation processuses the available data to train and test the model.

For example, as shown in a sales prediction process 1100, large company A has a 1118 on advertising expenditures and sales in a number (e.g. 10,000) of territories. The data is relatively large compared to, for example, data of a firm with 10 territories. The advertisement budget includes expenditures for point-of-sale displays in department stores, expenditures for TV media advertising and expenditures for radio media advertising. Based on the previous year sales Company A determines to improve next year's sales by adjusting the advertising budget. The process starts by obtaining the previous sales data, Step 1104, and prepares the previous sales data, Step 1106, for use. By fitting, Step 1108 a linear regression model with three predictors or explanatory variables for the expenditures (expenditures for point-of-sale displays, expenditure for TV advertising, and expenditure for radio advertising), wherein the response variable is sales, a fit of the linear regression analysis can be checked. Assuming that the linear regression analysis suggests a good fit, the model's ability to predict next year's sales based on new advertisements can be further analyzed. This is done by obtaining and evaluating predicted residuals 404 using accelerated k-fold cross-validation in Step 1110. Upon the evaluation satisfying a small error criterion in decision block 1112, the process can use the regression equation to predict sales for the next year by adjusting the advertising budget, Step 1114. Since the data is large, using many folds in the analysis improves the quality of estimates. The process ends at Step 1116. The sales prediction process 1100 can be performed entirely automatically or with the help of an operator, such as an analyst of Company A.

In another illustrative embodiment, a coronary heart disease prediction process 1200 is shown. Herein, a medical scientist has clinical data 1218 on a large number of patients obtained over several years. The clinical data 1218 includes patient age, hypertension status, weight, gender, and whether the patient has coronary heart disease (CHD). For this process, the response variable is a categorical variable with two levels coded as 0 (the patient does not have CHD) and 1 (the patient has CHD). The process starts at Step 1202. The process obtains the clinical data 1218, Step 1204 and prepares said clinical data 1218 for further use, Step 1206. The process then fits a generalized linear model (logistic regression) to the clinical data 1218 wherein the response is the patient CHD status, and the predictors are age, hypertension status (categorical), weight, and gender (categorical). A deviance and a deviance R-square statistic suggest a good fit. However, in order to predict CHD risk for patients that are not in the study (for example, future patients), a cross-validation is needed. Since the clinical data 1218 is large, an accelerated k-fold cross-validation is advantageous. The process performs an accelerated k-fold cross-validation of the model to obtain approximate predicted deviance residuals which are used to compute an approximate k-fold deviance R-square statistic. If this statistic is close to 1, decision block 1212, then the process can accurately predict the next patient's CHD risk through his/her age, hypertension status, gender, and weight. The process ends at Step 1216. The coronary heart disease prediction process 1200 can be performed entirely automatically or with the help of an operator, such as the medical scientist.

Any specific manifestations of these and other similar example processes are not intended to be limiting to the invention. Any suitable manifestation of these and other similar example processes can be selected within the scope of the illustrative embodiments.

Thus, a computer implemented method, system or apparatus, and computer program product are provided in the illustrative embodiments for k-fold cross-validation and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the dedicated learning machine 126 or user's computer, partly on the user's computer or learning machine 126 as a stand-alone software package, partly on the user's computer and partly on a remote computer or entirely on the remote computer or server, etc. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

What is claimed is:

1. A method comprising:
acquiring, via a predictive analytics engine of a learning machine, input data to be analyzed, the input data comprising a plurality of labeled cases;
training a model, based on a parameter estimation procedure, by using the plurality of labelled cases;
randomly dividing the plurality of labelled cases into a number of folds (k folds);
for each fold of the k folds, computing a set of corresponding predicted residuals in the fold using an inverse transformation of ordinary residuals representative of a difference between the output values of the labelled cases in the fold and their estimated or fitted values, the corresponding predicted residuals being representative of a bypassed traditional repetitive model training-then-testing process;
receiving k sets of corresponding predicted residuals; and
determining a k-fold R-square statistic using all the members of the k sets of corresponding predicted residuals, the k-fold R-square statistic being indicative of a k-fold cross-validation error of the model.

2. The method of claim 1, wherein at least one fold of the k folds contains more than one labelled case.

3. The method of claim 1, wherein the parameter estimation procedure is an ordinary least squares (OLS) method, and the model is a linear model.

4. The method of claim 3, further comprising using the k-fold cross-validation error to parameter tune when pruning a regression tree wherein k-fold cross-validation is applied a plurality of times to a sequence of subtrees indexed by a first tuning parameter and a second parameter that minimizes a first cross-validated error is used to select a final pruned regression tree.

5. The method of claim 1, wherein the parameter estimation procedure is an iterative reweighted least squares (IRLS) method and the model is a generalized linear model.

6. The method of claim 5, further comprising using the k-fold cross-validation error to parameter tune when pruning a classification tree, wherein k-fold cross-validation is applied a plurality of times to a sequence of subtrees indexed by a third tuning parameter and a fourth parameter that minimizes a second cross-validated error is used to select a final pruned classification tree.

7. The method of claim 5, further comprising computing the corresponding predicted residuals using a one-step approximation to deduce the parameter estimates of the generalized linear model based on all the labelled cases excluding the cases in a held-out fold from a generalized regression parameter estimation based on all labelled cases, wherein the corresponding predicted residuals are deviance residuals and wherein at least one fold of the k folds contains more than one labelled case.

8. The method of claim 1, wherein the predictive analytics engine is a machine learning model.

9. The method of claim 5, wherein the labelled cases comprise one or more input variables and an output variable, wherein the output variable has a distribution that is selected from the group consisting of a binomial distribution, a Poisson distribution, a gamma distribution, and a negative binomial distribution.

10. The method of claim 1, further comprising:
generating one or more other models; and
computing other corresponding predicted residuals for each of said one or more other models; and
selecting an optimal model for the labelled cases from among the model and the one or more other models based on the model with the highest the k-fold R-square statistic or equivalently the model with smallest k-fold cross-validation error.

11. The method of claim 1, the k folds have substantially a same size.

12. The method of claim 1, wherein an execution time of the computing is lower than another execution time of a corresponding computation of residuals using a traditional repetitive model training-then-testing process.

13. A non-transitory computer readable storage medium storing program instructions which, when executed by a processor, causes the processor to perform a procedure comprising the steps of:
acquiring, via a predictive analytics engine of a learning machine, input data to be analyzed, the input data comprising a plurality of labeled cases;
training a model, based on a parameter estimation procedure, by using the plurality of labelled cases;
randomly dividing the plurality of labelled cases into a number of folds (k folds);
for each fold of the k folds, computing a set of corresponding predicted residuals in the fold using an inverse transformation of ordinary residuals representative of a difference between the output values of the labelled cases in the fold and their estimated or fitted values, the corresponding predicted residuals being representative of a bypassed traditional repetitive model training-then-testing process;
receiving k sets of corresponding predicted residuals; and
determining a k-fold R-square statistic using all the members of the k sets of corresponding predicted residuals, the k-fold R-square statistic being indicative of a k-fold cross-validation error of the model.

14. The non-transitory computer readable storage medium of claim 13, wherein at least one fold of the k folds contains more than one labelled case.

15. The non-transitory computer readable storage medium of claim 13, wherein the parameter estimation procedure is an ordinary least squares (OLS) method and the model is a linear model.

16. The non-transitory computer readable storage medium of claim 13, wherein the parameter estimation procedure is an iterative reweighted least squares (IRLS) method and the model is a generalized linear model.

17. The non-transitory computer readable storage medium of claim 13, wherein the processor further performs the steps of:
generating one or more other models;
computing other corresponding predicted residuals for each of said one or more other models; and
selecting an optimal model for the labelled cases from among the model and the one or more other models based on the k-fold R-square statistic that that meets an evaluation criterion.

18. The non-transitory computer readable storage medium of claim 13, wherein an execution time of the computing is lower than another execution time of a corresponding computation of residuals associated with said bypassed traditional repetitive model training-then-testing process.

19. A computer system comprising:
at least one processor configured to performs the steps of:
acquiring, via a predictive analytics engine of a learning machine, input data to be analyzed, the input data comprising a plurality of labeled cases;
training a model, based on a parameter estimation procedure, by using the plurality of labelled cases;
randomly dividing the plurality of labelled cases into a number of folds (k folds);
for each fold of the k folds, computing a set of corresponding predicted residuals in the fold using an inverse transformation of ordinary residuals representative of a difference between the output values of the labelled cases in the fold and their estimated or fitted values, the corresponding predicted residuals being representative of a bypassed traditional repetitive model training-then-testing process;
receiving k sets of corresponding predicted residuals; and
determining a k-fold R-square statistic using all the members of the k sets of corresponding predicted residuals, the k-fold R-square statistic being indicative of a k-fold cross-validation error of the model.

20. The computer system of claim 19, wherein an execution time of the computing is lower than another execution time of a corresponding computation of residuals associated with said bypassed traditional repetitive model training-then-testing process.
